(19) United States
(12) Patent Application Publication
(10) Pub. No.: US 2011/0163981 A1
(43) Pub. Date: Jul. 7, 2011

(54) Manipulation direction judgment device, remote manipulation system, manipulation direction judgment method and program

(75) Inventors: Shin Ito, Tokyo (JP); Yoshinori Ohashi, Tokyo (JP); Eiju Yamada, Kanagawa (JP)

(73) Assignee: Sony Corporation, Tokyo (JP)

(21) Appl. No.: 12/928,904

(22) Filed: Dec. 22, 2010

(30) Foreign Application Priority Data
Jan. 4, 2010 (JP) P2010-000136

(51) Int. Cl. G06F 3/041

(52) U.S. Cl. 345/173

(57) ABSTRACT

There is provided a manipulation direction judgment device including a touch panel for detecting a movement start point and a movement end point of a pointer moving on a display panel, an angle area setting unit for setting a first angle area including at least two primary areas assigned different movement directions, respectively, and boundary areas forming boundaries between the primary areas, an angle area specifying unit for specifying an area in which an angle of a vector connecting the movement start point with the movement end point is located on the first angle area, and a manipulation direction judgment unit for judging the movement direction assigned to the primary area in which the angle of the vector is located, as a manipulation direction, using the first angle area only when the angle of the vector is located in the primary area.

### BACKGROUND OF THE INVENTION

1. Field of the Invention

The present invention relates to a manipulation direction judgment device, a remote manipulation system, a manipulation direction judgment method, and a program.

2. Description of the Related Art

In recent years, mobile devices such as commanders, PDAs, mobile phones and music players having a touch panel display have been used. In these mobile devices, an instruction of a user may be input by a pointer movement manipulation to designate any movement start point on a display. When the movement manipulation is performed, the mobile device judges a direction of the movement manipulation and executes processing according to the result of judging the manipulation direction.

### SUMMARY OF THE INVENTION

[Patent Literature 1] Japanese Patent Laid-open Publication No. Hei 5-197482

Even when a user has performed a movement manipulation with the intention of the same direction, a direction of the movement manipulation differs according to, for example, a manipulation method or a manipulation orientation. For example, the user holds the mobile device with one hand and performs the movement manipulation with a finger of the other hand or a stylus or performs the movement manipulation with a finger of the hand holding the mobile device (hereinafter, the former will be referred to as both-hand manipulation and the latter will be referred to as one-hand manipulation). In the both-hand manipulation and the one-hand manipulation, the direction of the movement manipulation differs due to the configuration of the hands.

Accordingly, when an ambiguous movement manipulation for which a manipulation direction is difficult to uniquely specify is performed, a misjudgment as to the manipulation direction may be made and processing intended by the user may not be properly executed. In particular, when a movement manipulation is performed without confirming an indication on a display, an ambiguous movement manipulation may be often performed and a misjudgment as to the manipulation direction is easily made.

In light of the foregoing, it is desirable to provide a manipulation direction judgment device, a remote manipulation system, a manipulation direction judgment method, and a program capable of suppressing a misjudgment when a manipulation direction is judged from a movement start point and a movement end point of a pointer.

According to an embodiment of the present invention, there is provided a manipulation direction judgment device including a manipulation detection unit for detecting a movement start point and a movement end point of a pointer moving on a display panel, an angle area setting unit for setting a first angle area including at least two primary areas assigned different movement directions, respectively, and boundary areas forming boundaries between the primary areas, an angle area specifying unit for specifying an area in which an angle of a vector connecting the movement start point with the movement end point is located on the first angle area, and a manipulation direction judgment unit for judging a movement direction assigned to the primary area in which the angle of the vector is located, as a manipulation direction, using the first angle area only when the angle of the vector is located in the primary area.

According to this configuration, since the manipulation direction is judged using the first angle area only when an angle of a vector is located in a primary area, a misjudgment as to the manipulation direction can be suppressed even when the angle of the vector is located in the boundary area and an ambiguous movement manipulation for which the manipulation direction is difficult to uniquely specify has been performed.

The angle area setting unit may set a second angle area including at least two areas respectively assigned different directions, the angle area specifying unit may specify, on the second angle area, a direction assigned to an area in which the movement start point is located and a direction assigned to an area in which the movement end point is located when the angle of the vector is located in the boundary area, and the manipulation direction judgment unit may judge the manipulation direction based on a relationship between the two specified directions.

The manipulation direction judgment unit may stop the judgment of the manipulation direction when the angle of the vector is located in the boundary area and the manipulation direction is difficult to uniquely specify using the second angle area.

The angle area setting unit may set the second angle area using a center of a contact detection area of the display panel as a reference.

The angle area setting unit may set the second angle area using a position deviated from a center of a contact detection area of the display panel as a reference, according to a manipulation condition.

The angle area setting unit may set the second angle area using at least two curves obtained in advance to be approximated to a movement locus of the pointer in a one-hand manipulation.

The manipulation direction judgment unit may judge the manipulation direction using the first angle area when a distance between the movement start point and the movement end point is equal to or more than a given threshold.

The manipulation direction judgment device may further include a remote manipulation unit for remotely manipulating an electronic device based on the result of judging the manipulation direction.

According to another embodiment of the present invention, there is provided a manipulation direction system including a manipulation direction judgment device and an electronic device remotely manipulated by the manipulation direction judgment device. The manipulation direction judgment device includes a manipulation detection unit for detecting a movement start point and a movement end point of a pointer moving on a display panel, an angle area setting unit for setting a first angle area including at least two primary areas assigned different movement directions, respectively, and boundary areas forming boundaries between the primary areas, an angle area specifying unit for specifying an area in which an angle of a vector connecting the movement start point with the movement end point is located on the first angle area, a manipulation direction judgment unit for judging a movement direction assigned to the primary area in which the angle of the vector is located, as a manipulation direction, using the first angle area only when the angle of the vector is located in the primary area, and a remote manipulation unit for remotely manipulating the electronic device based on the result of judging the manipulation direction.

According to another embodiment of the present invention, there is provided a manipulation direction judgment method including the steps of setting a first angle area including at least two primary areas assigned different movement directions, respectively, and boundary areas forming boundaries between the primary areas, specifying an area in which an angle of a vector connecting a movement start point of a pointer moving on a display panel with a movement end point thereof is located on the first angle area, and judging the movement direction assigned to the primary area in which the angle of the vector is located, as a manipulation direction, using the first angle area only when the angle of the vector is located in the primary area.

According to another embodiment of the present invention, there is provided a program for causing a computer to execute a manipulation direction judgment method, the manipulation direction judgment method including the steps of setting a first angle area including at least two primary areas assigned different movement directions, respectively, and boundary areas forming boundaries between the primary areas, specifying an area in which an angle of a vector connecting a movement start point of a pointer moving on a display panel with a movement end point thereof is located on the first angle area, and judging the movement direction assigned to the primary area in which the angle of the vector is located, as a manipulation direction, using the first angle area only when the angle of the vector is located in the primary area.

As described above, according to the present invention, it is possible to provide a manipulation direction judgment device, a remote manipulation system, a manipulation direction judgment method, and a program capable of suppressing a misjudgment when a manipulation direction is judged from a movement start point and a movement end point of a pointer.

### BRIEF DESCRIPTION OF THE DRAWINGS

FIG. 1 is a diagram showing an overview of a manipulation direction judgment method according to an embodiment of the present invention;

FIG. 2 is a diagram showing a remote manipulation system including a commander according to an embodiment of the present invention;

FIG. 3 is a diagram showing parameters indicating a flick manipulation;

FIG. 4 is a diagram showing a situation in which a manipulation direction is erroneously judged in a judgment method of a related art;

FIG. 5 is a block diagram showing an operation procedure of the commander;

FIG. 6 is a diagram showing one example of a set status of a first angle area;

FIG. 7 is a diagram showing one example of a set status of a second angle area;

FIG. 8A is a diagram (1/2) showing one example of manipulation direction judgment criteria using the second angle area;

FIG. 8B is a diagram (2/2) showing one example of the manipulation direction judgment criteria using the second angle area;

FIG. 9A is a diagram (1/2) showing a situation in which a misjudgment as to a manipulation direction is suppressed;

FIG. 9B is a diagram (2/2) showing the situation in which a misjudgment as to a manipulation direction is suppressed;

FIG. 10A is a diagram (1/2) showing a variant of a set status of the second angle area; and

FIG. 10B is a diagram (2/2) showing the variant of the set status of the second angle area.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### 1. OVERVIEW OF MANIPULATION DIRECTION JUDGMENT METHOD

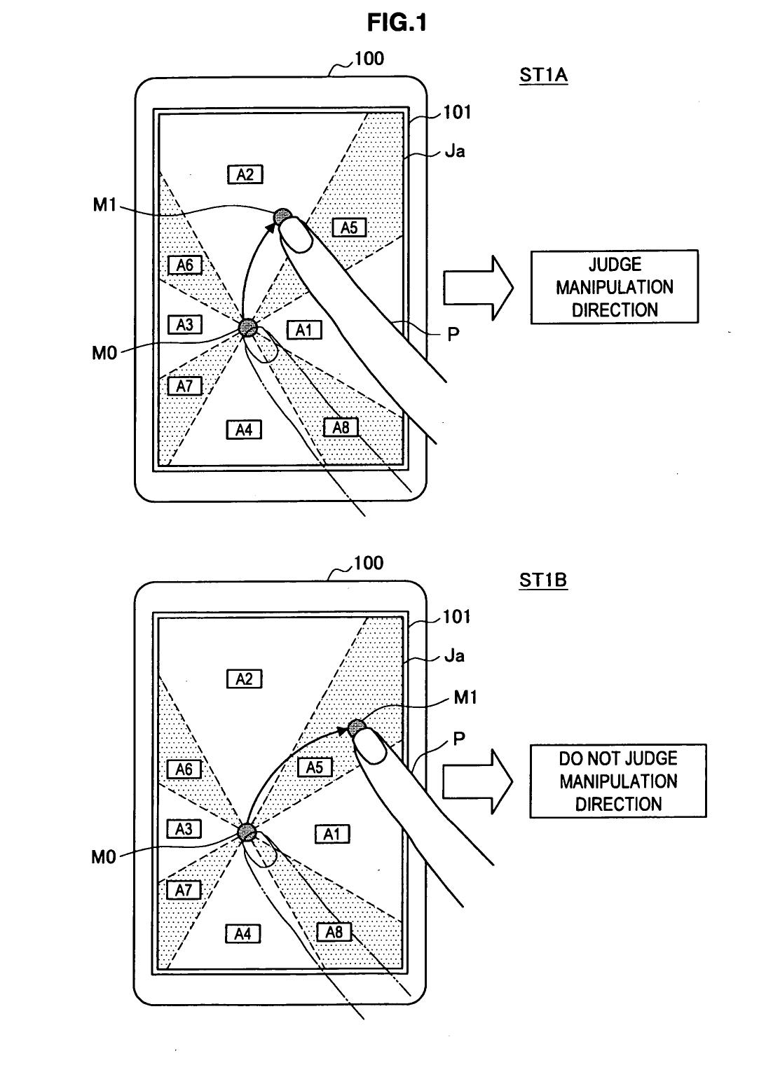

First, an overview of a manipulation direction judgment method according to an embodiment of the present invention will be described with reference to FIG. 1. While a case in which the judgment method is applied to a commander 100 as one example of a mobile device will be described hereinafter, a case in which the judgment method is applied to a mobile device other than the commander 100 may be described similarly.

As shown in FIG. 1, the commander 100 includes a touch panel display 101 and detects a movement start point M0 and a movement end point M1 of a pointer P, which moves on the display 101. The commander 100 sets a first angle area Ja including at least two primary areas assigned different movement directions, respectively, and boundary areas forming boundaries between the primary areas. In the example shown in FIG. 1, the first angle area Ja including four primary areas A1 to A4 assigned up, down, left and right directions, respectively, and boundary areas A5 to A8 forming boundaries between the primary areas is set.

When the movement start point M0 and the movement end point M1 of the pointer P moving on the display 101 have been detected, the commander 100 specifies an area in which an angle R of a vector (hereinafter, corresponding to the position of the movement end point M1 shown in FIG. 1) connecting the movement start point M0 with the movement end point M1 is located on the first angle area Ja. According to the result of specifying, the commander 100 judges a movement direction assigned to the primary area in which the angle R of the vector is located, as a manipulation direction, using the first angle area Ja only when the angle R of the vector is located in the primary area (the areas A1 to A4 in the example shown in FIG. 1).

Here, in a state ST1A, the angle R of the vector (corresponding to the position of the movement end point M1 shown in FIG. 1) is located in the primary area A2 assigned the up direction. In this case, the commander 100 judges the manipulation direction as the up direction based on the movement direction assigned to the primary area A2. Meanwhile, in a state ST1B, the angle R of the vector is located in the boundary area A5. In this case, since it is difficult for the commander 100 to uniquely specify the manipulation direction, the commander 100 does not judge the manipulation direction using the first angle area Ja.

Thus, since the commander 100 judges the manipulation direction using the first angle area Ja only when the angle R of the vector (corresponding to the position of the movement end point M1 shown in FIG. 1) is located in the primary area (in the example shown in FIG. 1, the areas A1 to A4), it is possible to suppress a misjudgment as to the manipulation direction even when the angle R of the vector is located in the boundary area (the areas A5 to A8) and an ambiguous movement manipulation for which the manipulation direction is difficult to uniquely specify has been performed.

### 2. CONFIGURATION OF COMMANDER 100

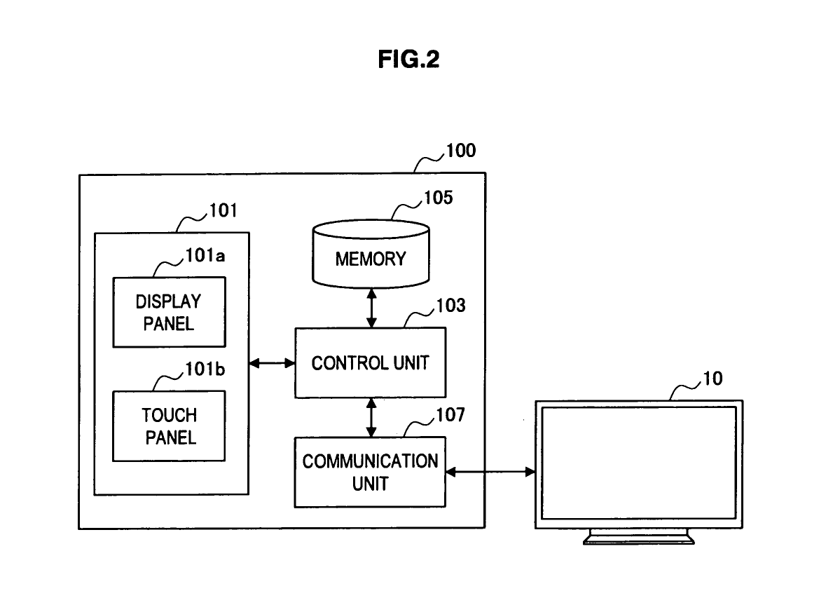

Next, a remote manipulation system including the commander 100 according to the embodiment of the present invention will be described with reference to FIG. 2.

As shown in FIG. 2, the remote manipulation system includes the commander 100 and a television receiver 10. The commander 100 is one example of a mobile device, including a commander, a PDA, a mobile phone, a music player and the like. The television receiver 10 is one example of an electronic device remotely manipulated by a user using the commander 100.

The commander 100 transmits a manipulation command to the television receiver 10 via a wired or wireless communication unit in order to remotely manipulate the television receiver 10. Alternatively, the commander 100 may transmit the manipulation command via a network.

The commander 100 includes a touch panel display 101, a control unit 103, a memory 105, and a communication unit 107.

The touch panel display 101 is configured by stacking a touch panel 101b on a display panel 101a. A panel of a resistance film type, a capacitance type, an ultrasonic type, or an infrared type is used as the touch panel 101b. For example, a liquid crystal display (LCD) is used as the display panel 101a.

The touch panel 101b detects a state of a contact of a pointer P, such as a finger or a stylus, with a panel surface and functions as a manipulation detection unit. The touch panel 101b supplies a contact signal/a release signal to the control unit 103 according to a change of a contact/non-contact state of the pointer P with the panel surface. Further, the touch panel 101b supplies an (X, Y) coordinate signal corresponding to a contact position to the control unit 103 while the pointer P is contacting the panel surface.

The control unit 103 includes a CPU, a RAM, a ROM and the like, and the CPU executes a program stored in the ROM using the RAM as a work memory and controls each unit of the commander 100. The control unit 103 functions as an angle area setting unit, an angle area specifying unit, a manipulation direction judgment unit, and a remote manipulation unit by executing the program.

The memory 105 is a non-volatile memory such as an EEPROM, and stores set data of the first and second angle areas Ja and Jb, data for a display, manipulation command information, and the like. The communication unit 107 transmits a given manipulation command to the television receiver 10 according to a manipulation input by a user.

The control unit 103 decodes the coordinate signal supplied from the touch panel 101b to generate coordinate data, and controls each unit of the commander 100 based on the coordinate data and the contact/release signal. The control unit 103 reads, from the memory 105, command information corresponding to the manipulation input according to the manipulation input by the user and transmits a given manipulation command for the television receiver 10 to the communication unit 107. The control unit 103 reads the data for a display stored in the memory 105, generates display data, and supplies the display data to the display panel 101a to display an image corresponding to the display data on the display panel 101a.

The control unit 103 sets the first angle area Ja including at least two primary areas assigned different movement directions, respectively, and boundary areas forming boundaries between the primary areas. The control unit 103 specifies an area in which the angle R of the vector connecting the movement start point M0 with the movement end point M1 is located on the first angle area Ja. Only when the angle R of the vector is located in the primary area, the control unit 103 judges a movement direction assigned to the primary area in which the angle R of the vector is located, as a manipulation direction, using the first angle area Ja.

### 3. MANIPULATION DIRECTION JUDGMENT METHOD

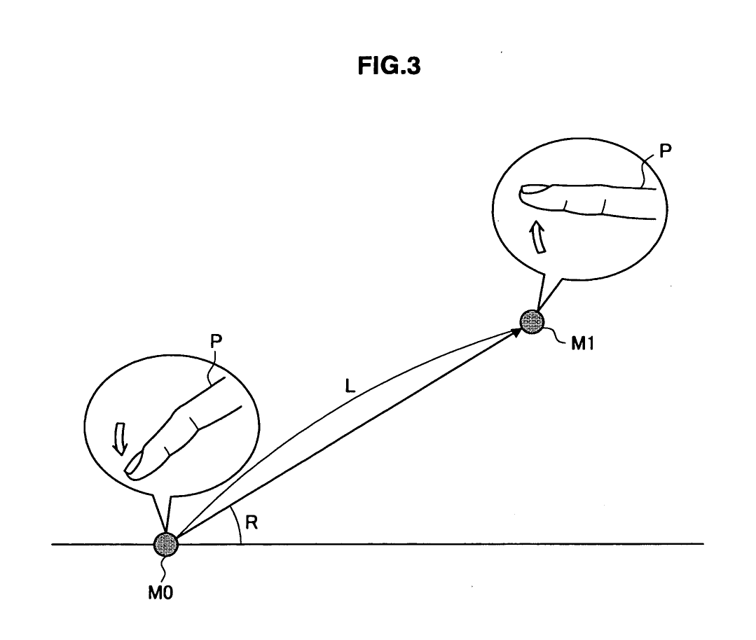

Next, a manipulation direction judgment method will be described with reference to FIGS. 3 to 10. First, a flick manipulation will be described with reference to FIG. 3.

In FIG. 3, parameters indicating a flick manipulation are shown. As shown in FIG. 3, the flick manipulation is indicated by using a movement start point M0, a movement end point M1, a movement distance L, and a movement angle R (an angle R of a vector) as parameters.

The flick manipulation is a manipulation to move the pointer P, which contacts a panel surface, in any direction on the panel surface. In the flick manipulation, a contact point indicating a transition from a non-contact state to a contact state is the movement start point M0, and a contact point indicating a transition from the contact state to the non-contact state is the movement end point M1. Further, a size of a vector connecting the movement start point M0 with the movement end point M1 is the movement distance L and the angle R of the vector with respect to a reference axis is the movement angle R.

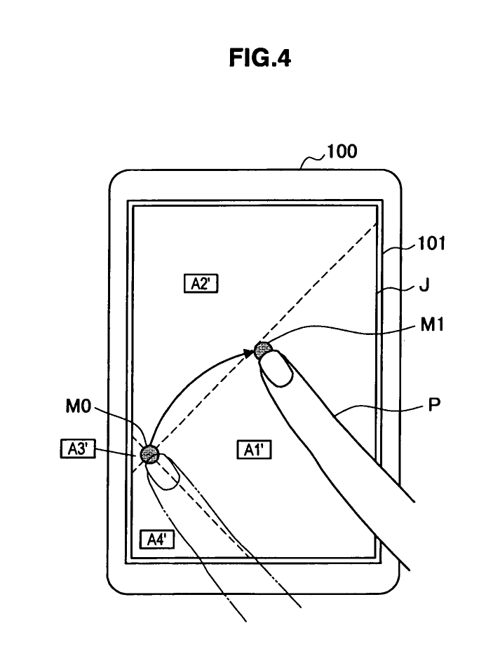

Next, a situation in which a manipulation direction is erroneously judged in a judgment method of a related art will be described with reference to FIG. 4.

As shown in FIG. 4, when a movement start point M0 and a movement end point M1 of a pointer P moving on a display panel 101a are detected, the commander 100 calculates the angle R of the vector connecting the movement start point M0 with the movement end point M1. The commander 100 judges a movement direction assigned to the angle R of the vector in advance as a manipulation direction. For example, when the angle R of the vector (hereinafter, corresponding to the position of the movement end point M1 shown in FIG. 4) is located in an angle area A1′ (R≦π/4 or 7π/4<R), the manipulation direction is judged as a right direction, and when the angle R is located in an angle area A2′ (π/4<R≦3π/4), the manipulation direction is judged as an up direction.

Here, it is assumed that a movement manipulation performed with the intention of the up direction is an ambiguous movement manipulation and the angle R of the vector is located in the angle area A1′. In this case, the commander 100 judges the manipulation direction as a right direction based on the movement direction assigned to the angle area A1′. As a result, since an ambiguous movement manipulation for which a manipulation direction is difficult to uniquely specify has been performed, a misjudgment as to the manipulation direction is made and processing intended by the user is not properly performed.

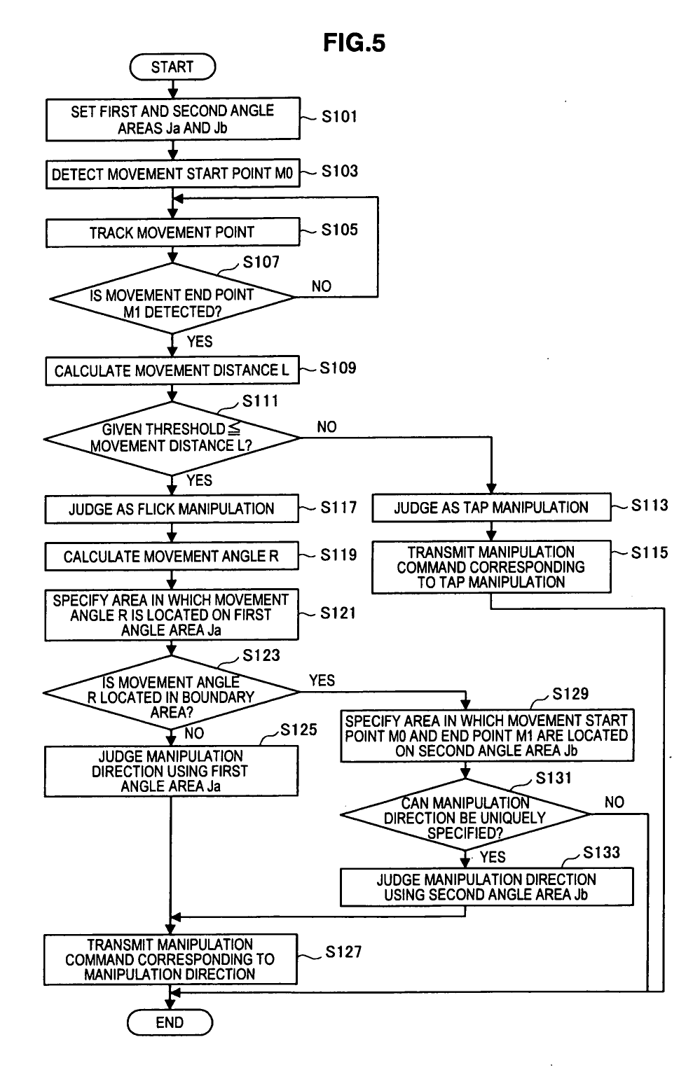

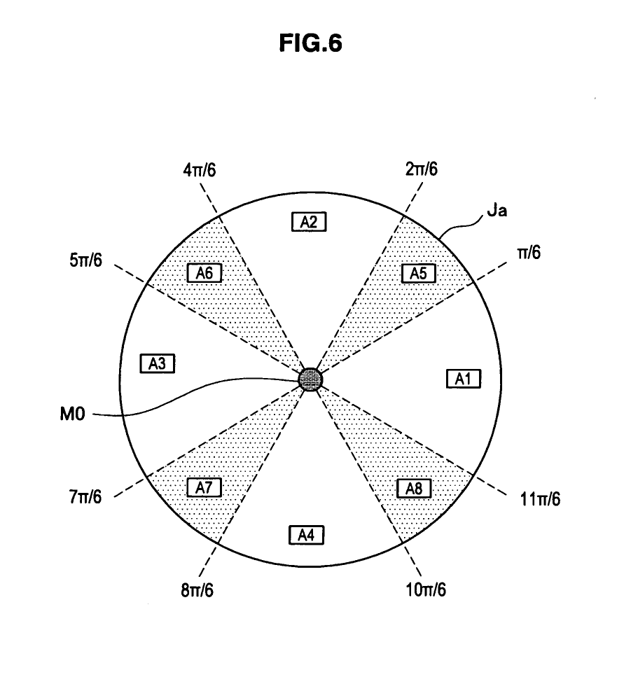

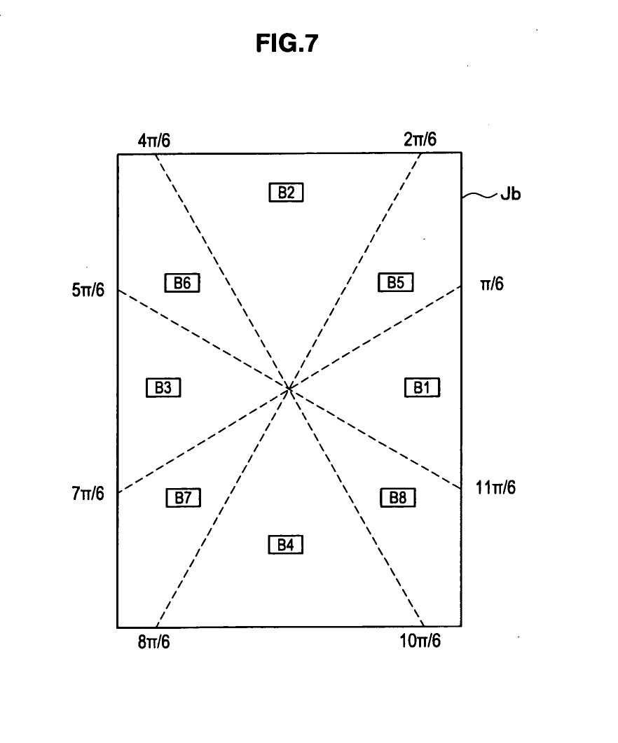

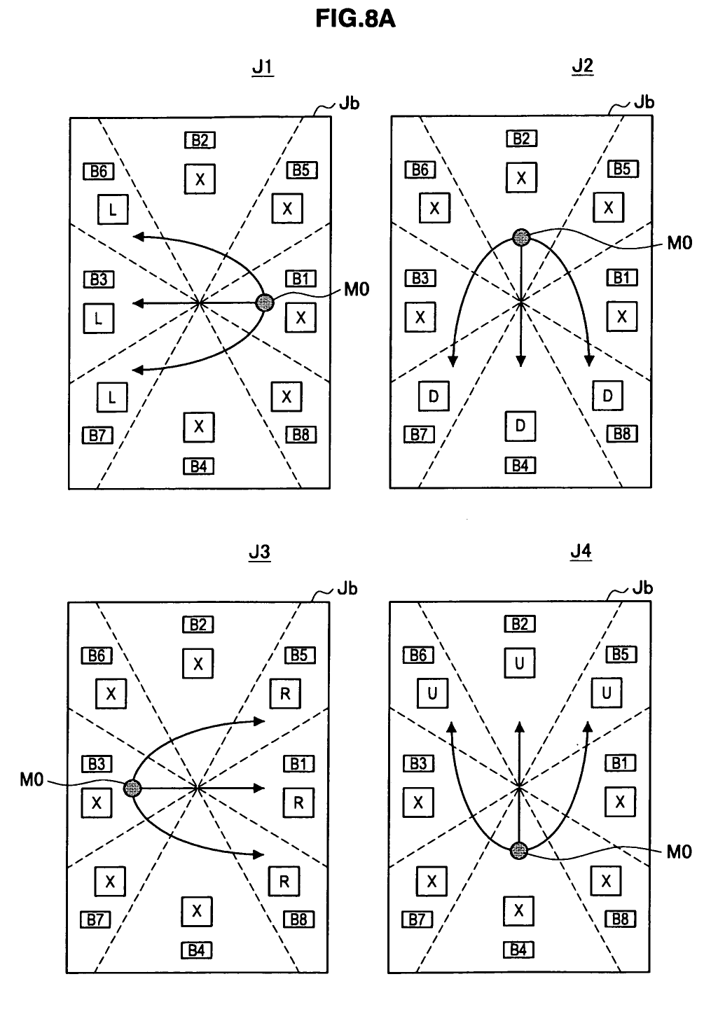

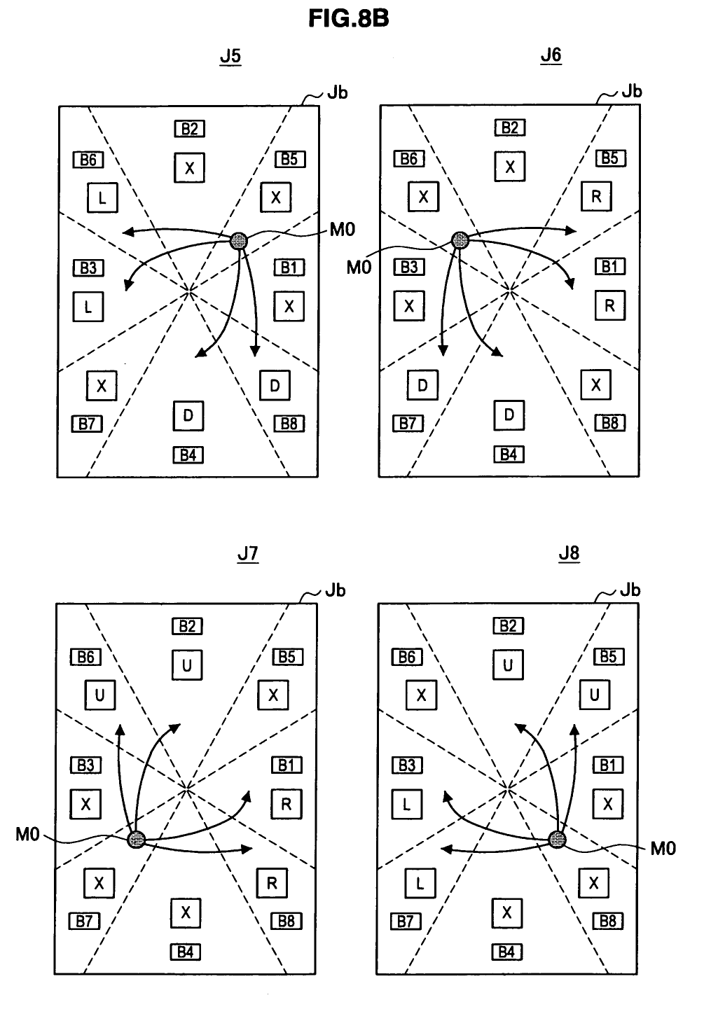

Next, a manipulation direction judgment method according to an embodiment of the present invention will be described with reference to FIGS. 5 to 8. In FIGS. 5 and 6, an operation procedure of the commander 100, and one example of a set status of the first angle area Ja are shown, respectively. Further, in FIGS. 7 and 8, one example of the set status of the second angle area Jb, and one example of manipulation direction judgment criteria using the second angle area Jb are shown, respectively.

As shown in FIG. 5, the commander 100 first sets first and second angle areas Ja and Jb, as illustrated in FIGS. 6 and 7 (step S101).

In the example shown in FIG. 6, the first angle area Ja is set which includes four primary areas A1 to A4 assigned up, down, left and right directions, respectively, and boundary areas A5 to A8 forming boundaries between the primary areas A1 to A4.

The primary areas A1 to A4 include a first area A1 (R≦π/6 or 11π/6≦R) assigned the right direction, a second area A2 (2π/6≦R≦4π/6) assigned the up direction, a third area A3 (5π/6≦R≦7π/6) assigned the left direction, and a fourth area A4 (8π/6≦R≦10π/6) assigned the down direction. Further, the boundary areas A5 to A8 include a fifth area A5 (π/6<R<2π/6), a sixth area A6 (4π/6<R<5π/6), a seventh area A7 (7π/6<R<8π/6), and an eighth area A8 (10π/6<R<11π/6), which form boundaries between the first to fourth areas.

While, in the example shown in FIG. 6, angle areas of 2π/6 and π/6 are assigned to the primary areas A1 to A4 and the boundary areas A5 to A8, respectively, angle areas different from those in the example shown in FIG. 6 may be assigned. Further, different angle areas may be assigned to the respective primary areas A1 to A4 or the respective boundary areas A5 to A8. Further, while in the example shown in FIG. 6, the primary areas A1 to A4 and the boundary areas A5 to A8 are disposed with point symmetry and axial symmetry, the primary areas A1 to A4 and the boundary areas A5 to A8 may be disposed without the point symmetry and the axial symmetry.

In the example shown in FIG. 7, the second angle area Jb including four primary areas B1 to B4 and boundary areas B5 to B8 forming boundaries between the primary areas B1 to B4 is set on the touch panel 101b using a center of the contact detection area of the touch panel 101b as a reference.

The primary areas B1 to B4 include a first area B1 (R≦π/6 or 11π/6≦R), a second area B2 (2π/6≦R≦4π/6), a third area B3 (5π/6≦R≦7π/6), and a fourth area B4 (8π/6≦R≦10π/6). Further, the boundary areas B5 to B8 include a fifth area B5 (π/6<R<2π/6), a sixth area B6 (4π/6<R<5π/6), a seventh area B7 (7π/6<R<8π/6), and an eighth area B8 (10π/6<R<11π/6), which form boundaries between the first to fourth areas B1 to B4.

Further, while the second angle area Jb is set with the same arrangement as the first angle area Ja in the example shown in FIG. 7, the second angle area Jb may be set with a different arrangement from the first angle area Ja. Further, in the second angle area Jb, the assignment of angle areas to the primary areas B1 to B4 and the boundary areas B5 to B8 and the arrangement of the primary areas B1 to B4 and the boundary areas B5 to B8 may be changed, as in the first angle area Ja that has been described.

When the first and second angle areas Ja and Jb have been set, the commander 100 detects the movement start point M0 of the pointer P (S103), tracks the movement of the pointer P (S105), and detects the movement end point M1 (S107). When the commander 100 has detected the movement end point M1, the commander 100 calculates a movement distance L from the movement start point M0 and the movement end point M1 (S109) and judges whether the movement distance L is equal to or more than a given threshold (S111).

When the movement distance L is less than the threshold, the commander 100 judges that the tap manipulation has been performed (S113) and transmits a manipulation command corresponding to the tap manipulation to the television receiver 10 (S115). On the other hand, when the movement distance L is equal to or more than the threshold, the commander 100 judges that a flick manipulation has been performed (S117), calculates a movement angle R from the movement start point M0 and the movement end point M1 (S119), and attempts to judge the manipulation direction using the first angle area Ja.

When the commander 100 has calculated the movement angle R, the commander 100 specifies an area in which the movement angle R is located on the first angle area Ja (S121), and judges whether the movement angle R is located in the boundary area (in an example shown in FIG. 6, any of the fifth to eighth areas A5 to A8), i.e., whether an ambiguous movement manipulation has been performed (S123). When the movement angle R is not located in the boundary area, the commander 100 judges the movement direction assigned to the primary area (in the example shown in FIG. 6, any of the first to fourth areas A1 to A4) in which the movement angle R is located, as the manipulation direction (S125), and transmits a manipulation command corresponding to the manipulation direction to the television receiver 10 (S127).

On the other hand, when the movement angle R is located in the boundary area, the commander 100 judges that the ambiguous movement manipulation has been performed and attempts to judge the manipulation direction using the second angle area Jb. The commander 100 specifies, on the second angle area Jb, two areas in which the movement start point M0 and the movement end point M1 are located, respectively (S129).

The commander 100 judges whether the manipulation direction can be uniquely specified according to the judgment criteria shown in FIGS. 8A and 8B based on a relationship between the direction assigned to one area and the direction assigned to the other area (S131).

In FIG. 8A, judgment criteria J1 to J4 when the movement start point M0 is located in first to fourth areas B1 to B4 as the primary areas are shown. In FIG. 8B, judgment criteria J5 to J8 when the movement start point M0 is located in fifth to eighth areas B5 to B8 as boundary areas are shown. In the respective areas B1 to B8 of FIGS. 8A and 8B, the judgment result is shown as any of “x,” “U,” “D,” “L” and “R.” Here, the judgment result “x” indicates a case in which the manipulation direction is difficult to uniquely specify, and the judgment results “U,” “D,” “L” and “R” indicate cases in which the manipulation directions can be specified as up, down, left and right directions, respectively.

For example, the judgment criterion J4 shown in FIG. 8A is a judgment criterion when the movement start point M0 is located in the fourth area B4 as the primary area. According to the judgment criterion J4, when the movement end point M1 is located in any of the second, fifth, and sixth areas B2, B5 and B6, the manipulation direction is judged as the up direction. On the other hand, when the movement end point M1 is located in another area, the manipulation direction is difficult to uniquely specify. Accordingly, the manipulation direction is not judged.

Further, the judgment criterion J7 shown in FIG. 8B is a judgment criterion when the movement start point M0 is located in the seventh area B7 as the boundary area. According to the judgment criterion J7, when the movement end point M1 is located in the second or sixth area B2 or B6, the manipulation direction is judged as the up direction, and when the movement end point M1 is located in the first or eighth area B1 or B8, the manipulation direction is judged as the right direction. On the other hand, when the movement end point M1 is located in another area, the manipulation direction is difficult to uniquely specify. Accordingly, the manipulation direction is not judged.

When the manipulation direction can be uniquely specified according to the judgment criterion, the commander 100 judges the manipulation direction based on a relationship between the movement start point M0 and the movement end point M1 (S133) and transmits a manipulation command corresponding to the manipulation direction to the television receiver 10 (S127). On the other hand, when the manipulation direction is difficult to uniquely specify, the commander 100 does not transmit the manipulation command to the television receiver 10. Here, the commander 100 may urge the user to execute the movement manipulation.

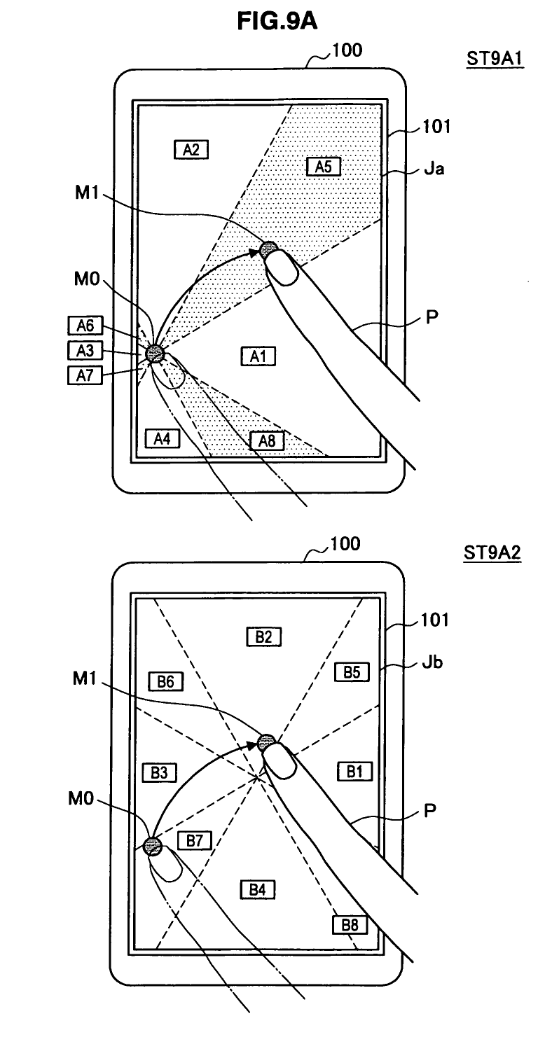

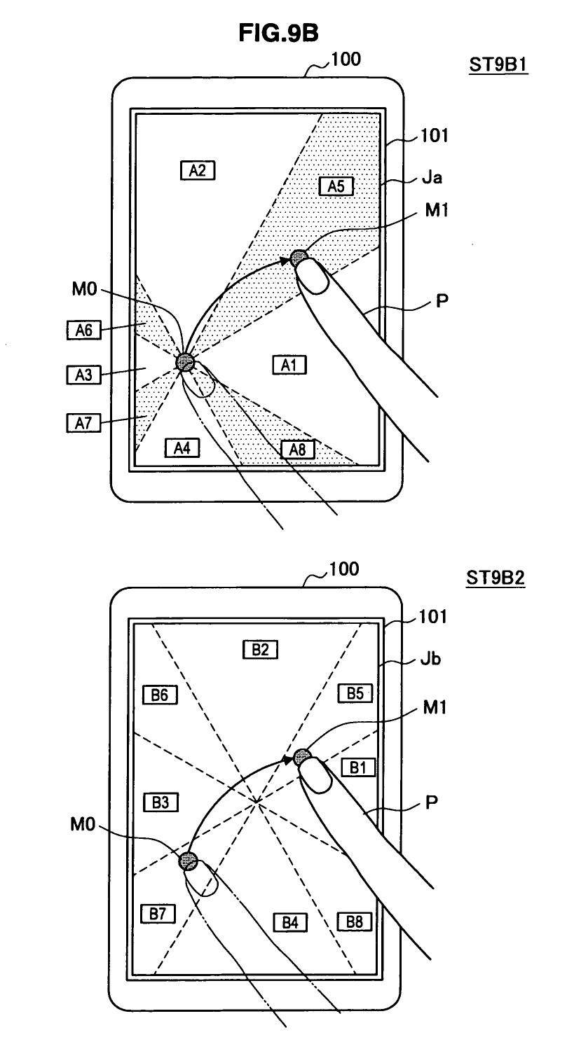

In FIGS. 9A and 9B, a situation in which the misjudgment as to the manipulation direction is suppressed by the judgment method according to the present embodiment is shown.

As shown in a state ST9A1 shown in FIG. 9A, the commander 100 sets a first angle area Ja including four primary areas A1 to A4 assigned up, down, left and right directions, respectively, and boundary areas A5 to A8 forming boundaries between the primary areas A1 to A4.

When the commander 100 has detected a movement start point M0 and a movement end point M1 of a pointer P, the commander 100 specifies an area in which the angle R of the vector (corresponding to the position of the movement end point M1 in FIG. 9A) connecting the movement start point M0 with the movement end point M1 is located on the first angle area Ja. The commander 100 judges whether the movement angle R is located in the boundary area (any of the fifth to eighth areas A5 to A8), i.e., whether an ambiguous movement manipulation has been performed. In the state ST9A1, since the movement angle R is located in the fifth area A5 as the boundary area, it is judged that the ambiguous movement manipulation has been performed.

When it is judged that the ambiguous movement manipulation has been performed, the commander 100 sets a second angle area Jb including four primary areas B1 to B4 and boundary areas B5 to B8 forming boundaries between the primary areas B1 to B4. The commander 100 specifies areas in which the movement start point M0 and the movement end point M1 are located on the second angle area Jb, respectively. The commander 100 judges whether an ambiguous movement manipulation has been performed based on a position relationship between the movement start point M0 and the movement end point M1. In a state ST9A2 shown in FIG. 9A, since the movement start point M0 is located in the seventh area B7, the movement end point M1 is located in the second area B2, and the manipulation direction can be uniquely specified according to the judgment criterion J7, the manipulation direction is judged as the up direction.

Meanwhile, in a state ST9B1 shown in FIG. 9B, since the movement angle R is located in the fifth area A5 as the boundary area, it is judged that an ambiguous movement manipulation has been performed. In a state ST9B2 shown in FIG. 9B, since the movement start point M0 is located in the seventh area B7, the movement end point M1 is located in the fifth area B5, and the manipulation direction is difficult to uniquely specify, the manipulation direction is not judged.

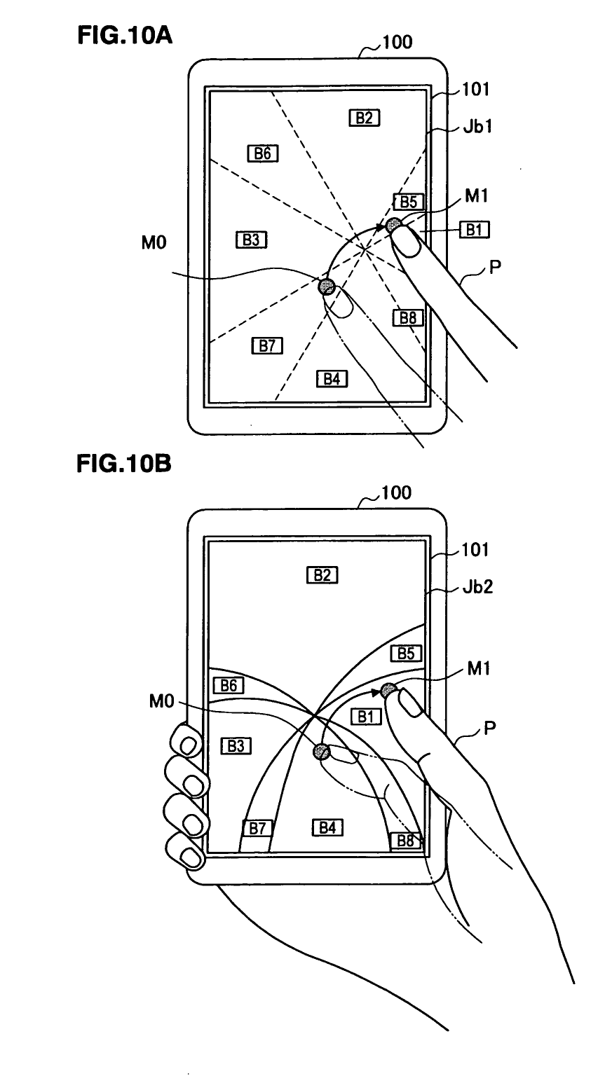

In FIGS. 10A and 10B, variants of the set status of the second angle area Jb are shown.

In FIG. 10A, one example of the second angle area Jb set in consideration of a manipulation orientation of a user is shown. According to a manipulation orientation of the user, a movement manipulation may be performed using a specific area (e.g., a right area) on the display 101, as shown in FIG. 10A. In this case, when the second angle area Jb is set using a center of a contact detection area of the display 101 as a reference, the manipulation direction may not be uniquely specified.

Accordingly, in the example shown in FIG. 10A, the second angle area Jb1 is set using a position deviated from the center of the contact detection area of the display 101 as a reference. Accordingly, it is possible to suppress the misjudgment as to the manipulation direction according to the manipulation orientation of the user.

In FIG. 10B, one example of the second angle area Jb set in a one-hand manipulation is shown. In the one-hand manipulation, even when a movement manipulation has been performed with the intention of the same direction, the movement manipulation direction differs from that in a both-hand manipulation due to the configuration of the hands.

For example, it is assumed that the commander 100 is one-hand manipulated using a thumb of a right hand as the pointer P in a state in which the commander 100 is held by the right hand so that a base of the thumb is located in a right lower portion of the commander 100. When the user performs a movement manipulation with the intention of an up direction, the thumb moves as the pointer P to draw an arc toward the top right of the commander 100 using the base as a rotational axis. In this case, when the second angle area Jb is set using at least two straight lines, it may be difficult to uniquely specify the manipulation direction.

Accordingly, in the example shown in FIG. 10B, the second angle area Jb2 is set using at least two curves obtained in advance to be approximated to a movement locus of the pointer P in the one-hand manipulation. Accordingly, it is possible to suppress a misjudgment as to the manipulation direction in the one-hand manipulation.

### 4. CONCLUSION

As described above, according to the manipulation direction judgment method in the embodiment of the present invention, since the manipulation direction is judged using the first angle area Ja only when the angle R of the vector is located in the primary area, it is possible to suppress a misjudgment as to the manipulation direction even when the angle R of the vector is located in the boundary area and an ambiguous movement manipulation for which the manipulation direction is difficult to uniquely specify has been performed.

While the preferred embodiments of the present invention have been described above with reference to the accompanying drawings, the present invention is not limited to the above examples, of course. A person skilled in the art may find various alternations and modifications within the scope of the appended claims, and it should be understood that they will naturally come under the technical scope of the present invention.

For example, in the foregoing, the case in which the manipulation direction judgment method according to the embodiment of the present invention is applied to the flick manipulation has been described. However, the manipulation direction judgment method according to the embodiment of the present invention may be applied to a swipe and hold manipulation. The swipe and hold manipulation is a manipulation to bring the pointer P into contact with the panel surface, move (swipe) the contacted pointer P on the panel surface and then hold the contacted pointer P.

In the swipe and hold manipulation, a contact point indicating the start of a movement in a contact state is the movement start point M0 and a contact point indicating the end of the movement in the contact state is the movement end point M1. Further, the start and the end of the movement in the contact state are judged based on the size of a position change of the contact point in a given time.

While the case in which the first and second angle areas Ja and Jb are set to have the four primary areas A1 to A4 and B1 to B4 has been described, the first and second angle areas Ja and Jb may be set to have two or three primary areas or at least five primary areas.

In the foregoing, the case in which the commander 100 transmits the command corresponding to the result of judging the manipulation direction based on the manipulation direction judgment result has been described. However, the commander 100 may be configured to execute an internal process other than the command transmission process based on the judgment result.

The present application contains subject matter related to that disclosed in Japanese Priority Patent Application JP 2010-000136 filed in the Japan Patent Office on Jan. 4, 2010, the entire content of which is hereby incorporated by reference.

What is claimed is:

1. A manipulation direction judgment device comprising:
a manipulation detection unit for detecting a movement start point and a movement end point of a pointer moving on a display panel;
an angle area setting unit for setting a first angle area including at least two primary areas assigned different movement directions, respectively, and boundary areas forming boundaries between the primary areas;
an angle area specifying unit for specifying an area in which an angle of a vector connecting the movement start point with the movement end point is located on the first angle area; and
a manipulation direction judgment unit for judging a movement direction assigned to the primary area in which the angle of the vector is located, as a manipulation direction, using the first angle area only when the angle of the vector is located in the primary area.

2. The manipulation direction judgment device according to claim 1,
wherein the angle area setting unit sets a second angle area including at least two areas respectively assigned different directions,
the angle area specifying unit specifies, on the second angle area, a direction assigned to an area in which the movement start point is located and a direction assigned to an area in which the movement end point is located when the angle of the vector is located in the boundary area, and
the manipulation direction judgment unit judges the manipulation direction based on a relationship between the two specified directions.

3. The manipulation direction judgment device according to claim 2,
wherein the manipulation direction judgment unit stops the judgment of the manipulation direction when the angle of the vector is located in the boundary area and the manipulation direction is difficult to uniquely specify using the second angle area.

4. The manipulation direction judgment device according to claim 2,
wherein the angle area setting unit sets the second angle area using a center of a contact detection area of the display panel as a reference.

5. The manipulation direction judgment device according to claim 2,
wherein the angle area setting unit sets the second angle area using a position deviated from a center of a contact detection area of the display panel as a reference, according to a manipulation condition.

6. The manipulation direction judgment device according to claim 2,
wherein the angle area setting unit sets the second angle area using at least two curves obtained in advance to be approximated to a movement locus of the pointer in a one-hand manipulation.

7. The manipulation direction judgment device according to claim 1,
wherein the manipulation direction judgment unit judges the manipulation direction using the first angle area when a distance between the movement start point and the movement end point is equal to or more than a given threshold.

8. The manipulation direction judgment device according to claim 1, further comprising a remote manipulation unit for remotely manipulating an electronic device based on the result of judging the manipulation direction.

9. A manipulation direction system including a manipulation direction judgment device and an electronic device remotely manipulated by the manipulation direction judgment device,
wherein the manipulation direction judgment device comprises:
a manipulation detection unit for detecting a movement start point and a movement end point of a pointer moving on a display panel;
an angle area setting unit for setting a first angle area including at least two primary areas assigned different movement directions, respectively, and boundary areas forming boundaries between the primary areas;
an angle area specifying unit for specifying an area in which an angle of a vector connecting the movement start point with the movement end point is located on the first angle area;
a manipulation direction judgment unit for judging a movement direction assigned to the primary area in which the angle of the vector is located, as a manipulation direction, using the first angle area only when the angle of the vector is located in the primary area; and
a remote manipulation unit for remotely manipulating the electronic device based on the result of judging the manipulation direction.

10. A manipulation direction judgment method comprising the steps of:
setting a first angle area including at least two primary areas assigned different movement directions, respectively, and boundary areas forming boundaries between the primary areas;
specifying an area in which an angle of a vector connecting a movement start point of a pointer moving on a display panel with a movement end point thereof is located on the first angle area; and
judging the movement direction assigned to the primary area in which the angle of the vector is located, as a manipulation direction, using the first angle area only when the angle of the vector is located in the primary area.

11. A program for causing a computer to execute a manipulation direction judgment method, the manipulation direction judgment method comprising the steps of:
setting a first angle area including at least two primary areas assigned different movement directions, respectively, and boundary areas forming boundaries between the primary areas;
specifying an area in which an angle of a vector connecting a movement start point of a pointer moving on a display panel with a movement end point thereof is located on the first angle area; and
judging the movement direction assigned to the primary area in which the angle of the vector is located, as a manipulation direction, using the first angle area only when the angle of the vector is located in the primary area.
